(19) United States
(12) Patent Application Publication
(10) Pub. No.: US 2007/0196669 A1
(43) Pub. Date: Aug. 23, 2007

(54) Mezzanine type opaque glass assembly having light permeable feature

(76) Inventor: Kang Mei, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/357,683

(22) Filed: Feb. 21, 2006

(51) Int. Cl. B32B 17/06; B32B 17/10

(52) U.S. Cl. 428/436; 428/426; 428/441

(57) ABSTRACT

A glass assembly includes two sheets of transparent glass, and an opaque film mounted between the two sheets of transparent glass. Thus, the glass assembly has an image opaque feature to isolate the image and also has a light permeable feature, so that the glass assembly not only has a sheltering effect to protect the privacy exactly but also allows passage of the light to enhance the light permeability. In addition, the mineral particles of the opaque film are distributed evenly, so that when the mineral particles are added into the film element to form the opaque film, the opaque film allows passage of the light through the glass assembly, so that the glass assembly has a light permeable feature.

### BACKGROUND OF THE INVENTION

1. Field of the Invention

The present invention relates to a glass assembly, and more particularly to a mezzanine type opaque glass assembly having a light permeable feature.

2. Description of the Related Art

A conventional glass assembly in accordance with the prior art shown in FIG. 3 comprises a transparent glass 11, and an opaque bonding paper 12 bonded onto the transparent glass 11 and having a surface provide with patterns 120. Thus, the glass assembly has a sheltering effect to protect the privacy. However, the bonding paper 12 is easily detached from the transparent glass 11 during a long-term utilization. In addition, the patterns 120 on the bonding paper 12 are easily worn or faded due to a moisture, especially in the bathroom, thereby decreasing the aesthetic quality of the glass assembly.

Another conventional glass assembly in accordance with the prior art shown in FIG. 4 comprises two sheets of transparent glass 21, a pattern layer 23 mounted between the two sheets of transparent glass 21, and two bonding layers 22 each mounted between the pattern layer 23 and a respective one of the two sheets of transparent glass 21. Thus, the pattern layer 23 is protected by the two sheets of transparent glass 21, thereby preventing the pattern layer 23 from being worn out. However, the glass assembly cannot allow passage of the light, so that the glass assembly interrupts the incident light completely, thereby greatly decreasing the light illuminating effect.

### SUMMARY OF THE INVENTION

In accordance with the present invention, there is provided a glass assembly, comprising two sheets of transparent glass, and an opaque film mounted between the two sheets of transparent glass.

The primary objective of the present invention is to provide a mezzanine type opaque glass assembly having a light permeable feature.

Another objective of the present invention is to provide a glass assembly that has an image opaque feature to isolate the image and also has a light permeable feature, so that the glass assembly not only has a sheltering effect to protect the privacy exactly but also allows passage of the light to enhance the light permeability, so as to satisfy the user's practical requirement, thereby enhancing the versatility of the glass assembly.

A further objective of the present invention is to provide a glass assembly, wherein the mineral particles of the opaque film are tiny and are distributed evenly, so that when the mineral particles are added into the film element to form the opaque film, the opaque film will not interrupt the light beams of the light source to allow passage of the light beams through the glass assembly, so that the glass assembly has a light permeable feature.

A further objective of the present invention is to provide a glass assembly, wherein the number of the mineral particles is changed to adjust the light permeability of the glass assembly, so that the light permeability of the glass assembly is adjusted according to the practical requirement, thereby enhancing the versatility of the glass assembly.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a glass assembly in accordance with the preferred embodiment of the present invention.

FIG. 2 is a schematic plan operational view of the glass assembly as shown in FIG. 1 in use.

FIG. 3 is an exploded perspective view of a conventional glass assembly in accordance with the prior art.

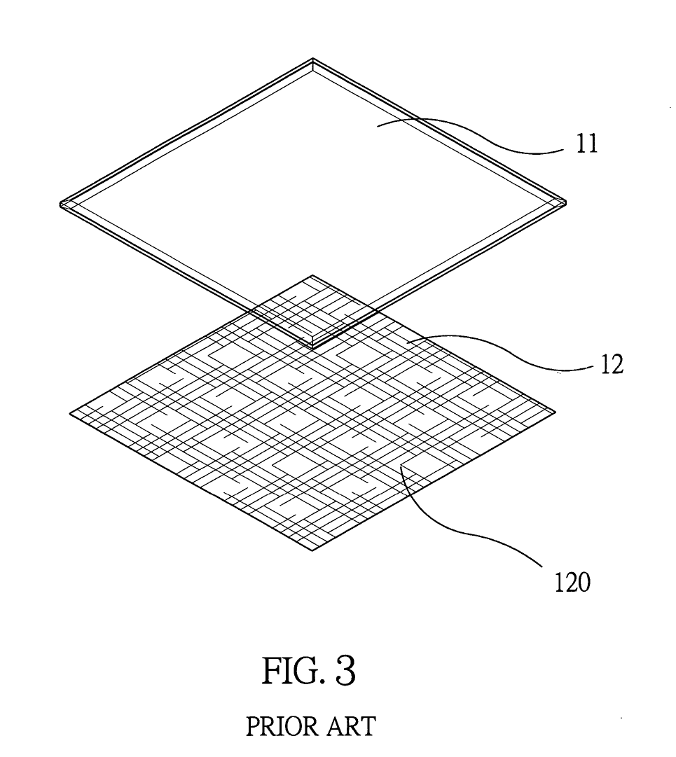

FIG. 4 is an exploded perspective view of another conventional glass assembly in accordance with the prior art.

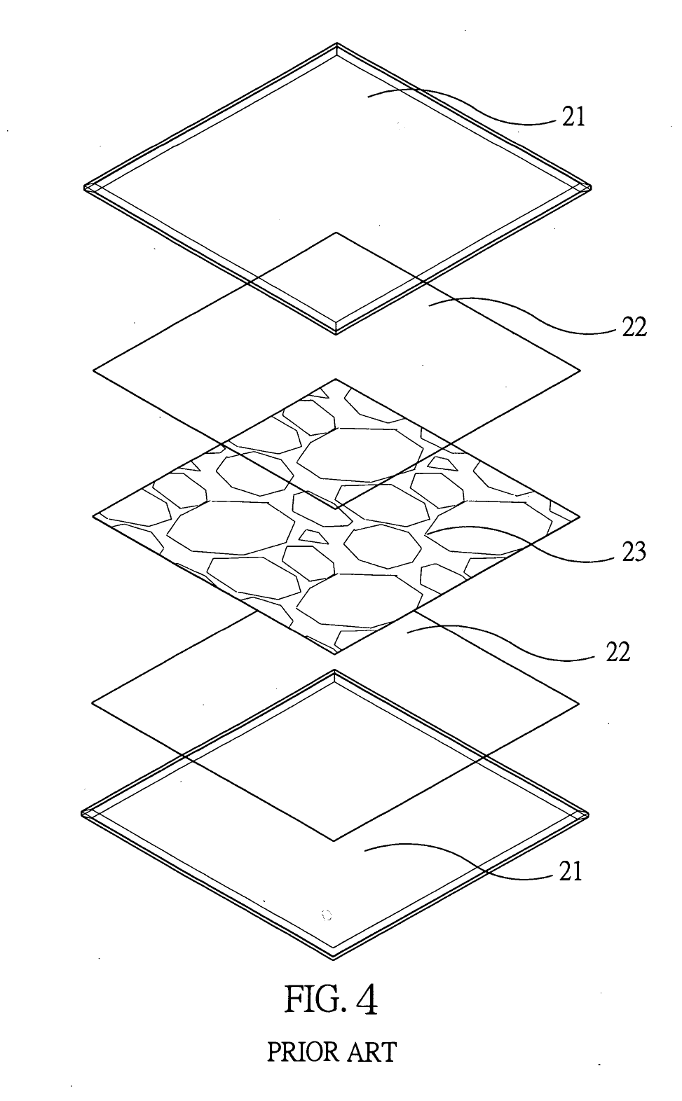

### DETAILED DESCRIPTION OF THE INVENTION

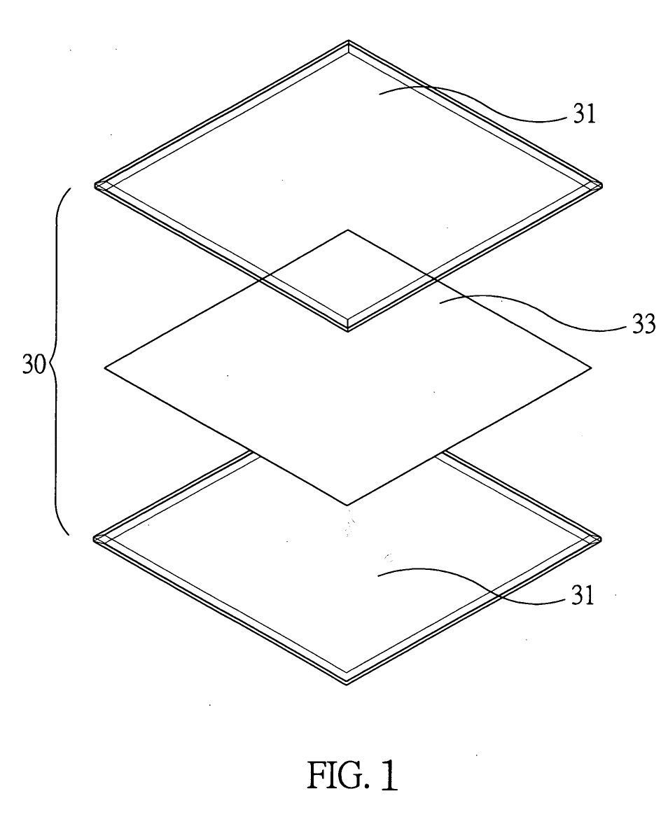

Referring to the drawings and initially to FIG. 1, a glass assembly 30 in accordance with the preferred embodiment of the present invention comprises two sheets of transparent glass 31, and an opaque film 33 mounted between the two sheets of transparent glass 31.

The opaque film 33 functions as a bonding interface of the two sheets of transparent glass 31. The opaque film 33 is mounted between the two sheets of transparent glass 31 by a heat press lamination process, so that the two sheets of transparent glass 31 and the opaque film 33 are combined with each other closely. The opaque film 33 has a slightly white color and a mist shape. The opaque film 33 consists of a film element and mineral particles which are added into the film element by a determined proportion. The film element is made by a material which is formed by a high molecular weight vinyl acetate and a high molecular weight epoxy methyl acrylic, wherein the high molecular weight vinyl acetate and the high molecular weight epoxy methyl acrylic are combined by a molecular bonding process to form the film element of the opaque film 33.

Thus, the mineral particles are added into the film element by a determined proportion during the melting process of the film element, so that the opaque film 33 shelters the two sheets of transparent glass 31 efficiently, to transfer the transparent state of the two sheets of transparent glass 31 into a separating layer having a slightly white color and a mist shape, thereby providing a sheltering effect to the two sheets of transparent glass 31 by the opaque film 33 so that the glass assembly 30 has an image opaque feature.

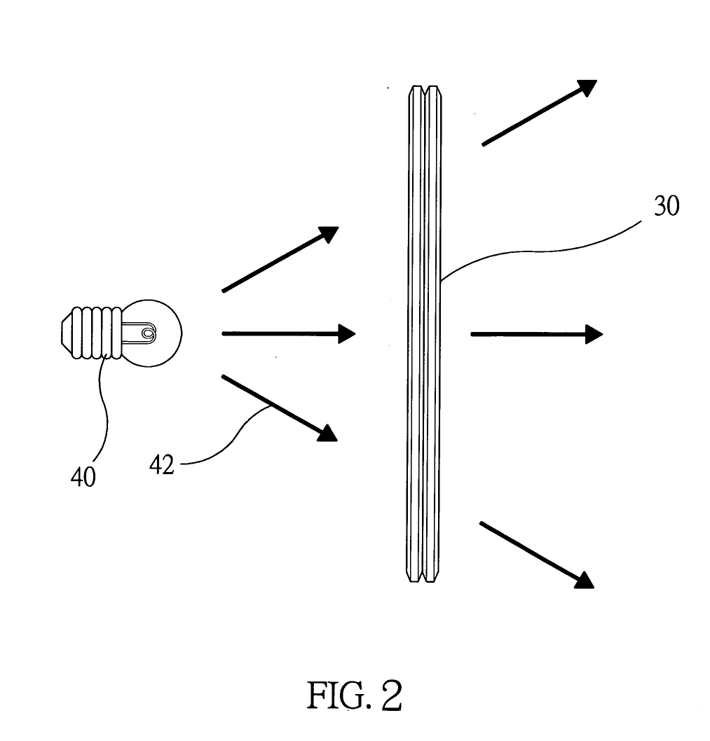

Referring to FIG. 2, when a light source 40 emits light beams outward, the light beams 42 are projected onto a side of the glass assembly 30. At this time, the mineral particles of the opaque film 33 are tiny and are distributed evenly, so that when the mineral particles are added into the film element to form the opaque film 33, the opaque film 33 will not interrupt the light beams 42 of the light source 40 to allow passage of the light beams 42 through the glass assembly 30, so that the glass assembly 30 has a light permeable feature. In addition, the number of the mineral particles is changed to adjust the light permeability of the glass assembly 30, so that the light permeability of the glass assembly 30 is adjusted according to the practical requirement, thereby enhancing the versatility of the glass assembly 30.

Further, the two sheets of transparent glass 31 and the opaque film 33 are combined by a heat press lamination process to form the glass assembly 30, so that the glass assembly 30 is assembled easily and rapidly, thereby saving the manual work and the working time. Further, the thickness of the opaque film 33 can be changed so as to enhance the structural strength of the glass assembly 30, so that when the glass assembly 30 is broken by an external impact, the fragments of the transparent glass 31 are adhered by the opaque film 33, thereby preventing the fragments of the transparent glass 31 from being thrown outward so as to provide a protective effect.

Accordingly, the glass assembly 30 has an image opaque feature to isolate the image and also has a light permeable feature, so that the glass assembly 30 not only has a sheltering effect to protect the privacy exactly but also allows passage of the light to enhance the light permeability, so as to satisfy the user's practical requirement, thereby enhancing the versatility of the glass assembly 30.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A glass assembly, comprising:
two sheets of transparent glass;
an opaque film mounted between the two sheets of transparent glass.

2. The glass assembly in accordance with claim 1, wherein the opaque film is mounted between the two sheets of transparent glass by a heat press lamination process, so that the two sheets of transparent glass and the opaque film are combined with each other closely.

3. The glass assembly in accordance with claim 1, wherein the opaque film consists of a film element and mineral particles which are added into the film element by a determined proportion.

4. The glass assembly in accordance with claim 3, wherein the film element is made by a material which is formed by a high molecular weight vinyl acetate and a high molecular weight epoxy methyl acrylic.

5. The glass assembly in accordance with claim 4, wherein the high molecular weight vinyl acetate and the high molecular weight epoxy methyl acrylic are combined by a molecular bonding process to form the film element of the opaque film.

6. The glass assembly in accordance with claim 1, wherein the opaque film has an image opaque feature to isolate an image and has a light permeable feature, so that the glass assembly not only has a sheltering effect but also allows passage of light to enhance a light permeability

7. The glass assembly in accordance with claim 1, wherein a number of the mineral particles is changed to adjust a light permeability of the glass assembly, so that the light permeability of the glass assembly is adjusted according to a practical requirement.

8. The glass assembly in accordance with claim 1, wherein a thickness of the opaque film can be changed according to a practical requirement.

9. The glass assembly in accordance with claim 1, wherein the opaque film functions as a bonding interface of the two sheets of transparent glass.

10. The glass assembly in accordance with claim 1, wherein the opaque film has a white color and a mist shape.
